(19) United States
(12) Patent Application Publication
(10) Pub. No.: US 2010/0252082 A1
(43) Pub. Date: Oct. 7, 2010

(54) Contact Lens Case and Solution container Travel Apparatus

(76) Inventor: Moo Young Lim, Mendon, UT (US)

Correspondence Address: Michael R. Schramm, 350 West 2000 South, Perry, UT, 84302, US

(21) Appl. No.: 11/961,996

(22) Filed: Dec. 20, 2007

(51) Int. Cl. B08B 13/00; A45C 11/04; B65D 6/00

(52) U.S. Cl. 134/115 R; 206/5.1; 220/4.26; 220/4.01

(57) ABSTRACT

The combined contact lens case and contact lens solution container apparatus is an invention that allows a user to conveniently carry both an off-the-shelf contact lens case and a container of contact lens solution in one compact package. Because the apparatus includes both the case and container, the apparatus avoids the problem of having contact lenses on-hand when traveling but not having contact lens solution. The contact lens case easily snaps into and out of the side of the contact lens solution container requiring minimal manual dexterity. The solution container, having a solution capacity of no more than three ounces, complies with air travel carry-on requirements, allowing the user to conveniently travel with apparatus whether by commercial air travel or by other modes of travel.

### BACKGROUND OF THE INVENTION

1. Field of the Invention

This invention relates to contact lens cases and containers of contact lens solution and in particular to combinations of convenient and compact contact lens cases and containers of contact lens solution.

2. Description of the Related Art

It is well known that users of contact lenses frequently need to place their contact lenses in cases containing contact lenses solution so as to clean, disinfect, and hydrate the contact lenses. Further, it is common for a user of contact lenses to need to seek out a container of contact lens solution for use in maintaining the contact lenses. The problem of locating a container of contact lens solution when needed is compounded when the user of contact lenses is traveling and the user's home medicine or storage container is not available. Furthermore, the problem of solution availability increased due to recent travel regulations which have imposed a limit of three ounces of liquid per airplane carried-on container.

Many improvements to contact lens cases and contact lens solution containers have been devised to improve convenience of using such lenses and such solution. For instance, the following list of US patents and applications all disclose inventions related to contact lens cases and/or contact lens solution containers and are incorporated herein by reference: U.S. Pat. Nos. 4,905,819, 5,127,517, 5,489,026, 5,489,027, 5,853,085, 6,729,835, 20040173474, 20060266661, D379,714, D390,356, and D427,427. However, the inventive concepts disclosed in the preceding list of patents include several deficiencies. Problems with the prior art include for instance complicated assemblies that require considerable dexterity and/or two hands to manipulate assembly, large volume solution containers that are not limited to three ounces of solution, require “plumbing” of the solution from a solution storage compartment to a lens storage compartment, do not accommodate a off-the-shelf lens case, or do not provide for convenient side-wall mounted lens cases. Furthermore, an apparatus that overcomes all of the above cited problems in a single product is heretofore unknown.

### SUMMARY OF THE INVENTION

The present invention has been developed in response to the present state of the art, and in particular, in response to the contact lens cases and/or contact lens solution containers that were described to be lacking in the art. Accordingly, the present invention is a combined off-the-shelf contact lens case and contact lens solution container travel apparatus. The case is snappingly engageable to and detachable from the side of the container. The container preferably has a contact lens solution capacity of no more than three ounces so as to be a convenient size for travel and so as to satisfy flight carry-on regulations. The container is adapted so as to allow easy engagement of the case to the side of the container by merely pressing the case into a “snapped-in” engagement with the container. The container is further adapted so as to effect the removal of a contact lens case that is snappingly engaged to the container by merely pressing on either end of the case which causes the case to rock or move about a land in a pocket in the container and causing the case to become disengaged. Engagement and disengagement of the case to the container is simply enough that it may be engaged and disengaged by a user using only one hand. The case and container are otherwise used in a convention manner to provide solution to a contact lens container.

Reference throughout this specification to features, advantages, or similar language does not imply that all of the features and advantages that may necessarily be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### DESCRIPTION OF DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an isometric view of a first embodiment of the apparatus;

FIG. 2 is an exploded isometric view of a first embodiment of the apparatus;

FIG. 3 is a plan section-view of a first embodiment of the apparatus taken at the location indicated in FIG. 1 with geometry such as a lid of the contact case that is forward of the section-view arrows shown in the section-view;

FIG. 4 which is substantially similar to FIG. 3, is a plan section-cut of a first embodiment of the apparatus taken at the location indicated in FIG. 1 with geometry that is forward of the section-cut arrows not shown in the section-cut;

FIG. 5 is a side section-cut of a first embodiment of the apparatus taken at the location indicated in FIG. 1 with geometry that is forward of the section-cut arrows not shown in the section-cut. The contact lens case is shown engaged to the contact lens solution container, and;

FIG. 6 is a side section-cut of a first embodiment of the apparatus taken at the location indicated in FIG. 1 with geometry that is forward of the section-cut arrows not shown in the section-cut. The contact lens case is shown in a state of disengagement from the contact lens solution container.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The invention is a combined contact lens case and contact lens solution container apparatus. The container preferably has a solution capacity of no more than three ounces and the case preferably easily snaps into and out of a side of the container. In order to facilitate the understanding of the present invention in reviewing the drawings accompanying the specification, a feature list is provided below. It is noted that like features are like numbered throughout all of the figures.

FEATURE TABLE

| # | Feature |
|---|---|
| 10 | Lens case and solution container apparatus |
| 20 | Container |
| 21 | Bottle |
| 22 | Bottle top |
| 23 | Bottle side |
| 24 | Bottle neck |
| 25 | Bottle mouth |
| 26 | Bottle pocket |
| 28 | Bottle pocket lower recess |
| 30 | Bottle pocket upper recess |
| 32 | Bottle pocket land |
| 34 | First bottle pocket retaining flange |
| 36 | Second bottle pocket retaining flange |
| 38 | Bottle bottom |
| 40 | Spout |
| 42 | Spout nozzle |
| 44 | Spout flange |
| 46 | Spout collar |
| 50 | Cap |
| 52 | Cap knurled surface |
| 60 | Contact lens case |
| 62 | Case base member |
| 64 | Left lens receiving recess |
| 66 | Right lens receiving recess |
| 68 | Left lens lid |
| 69 | Left lens lid knurled surface |
| 70 | Right lens lid |
| 71 | Right contact lens knurled surface |
| 72 | Left contact lens |
| 74 | Right contact lens |
| 80 | Contact lens solution |

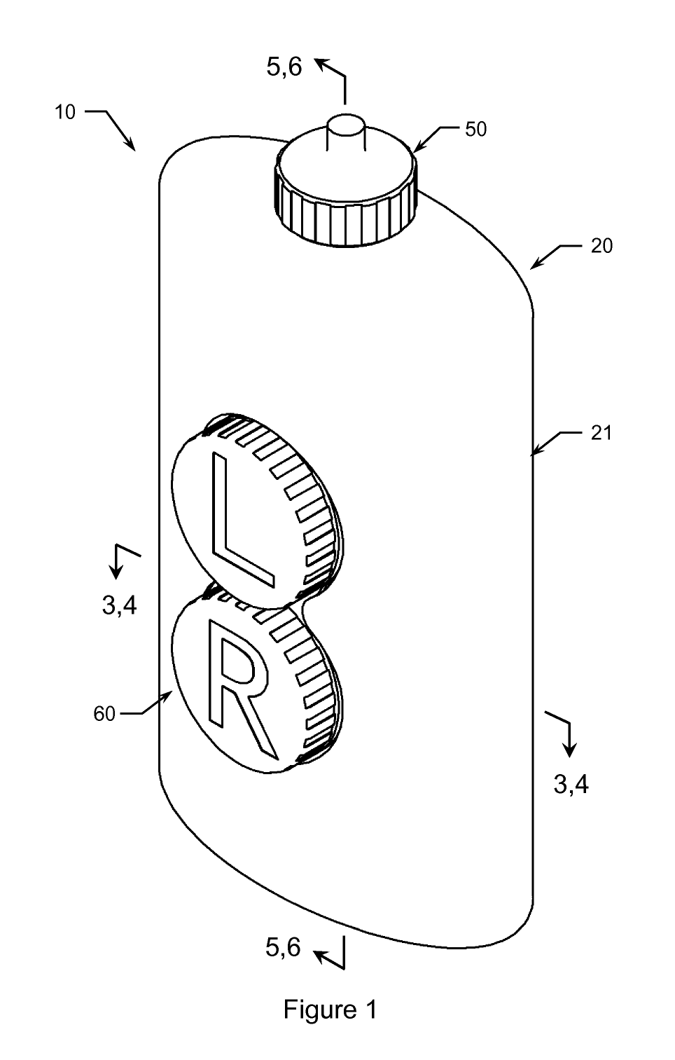

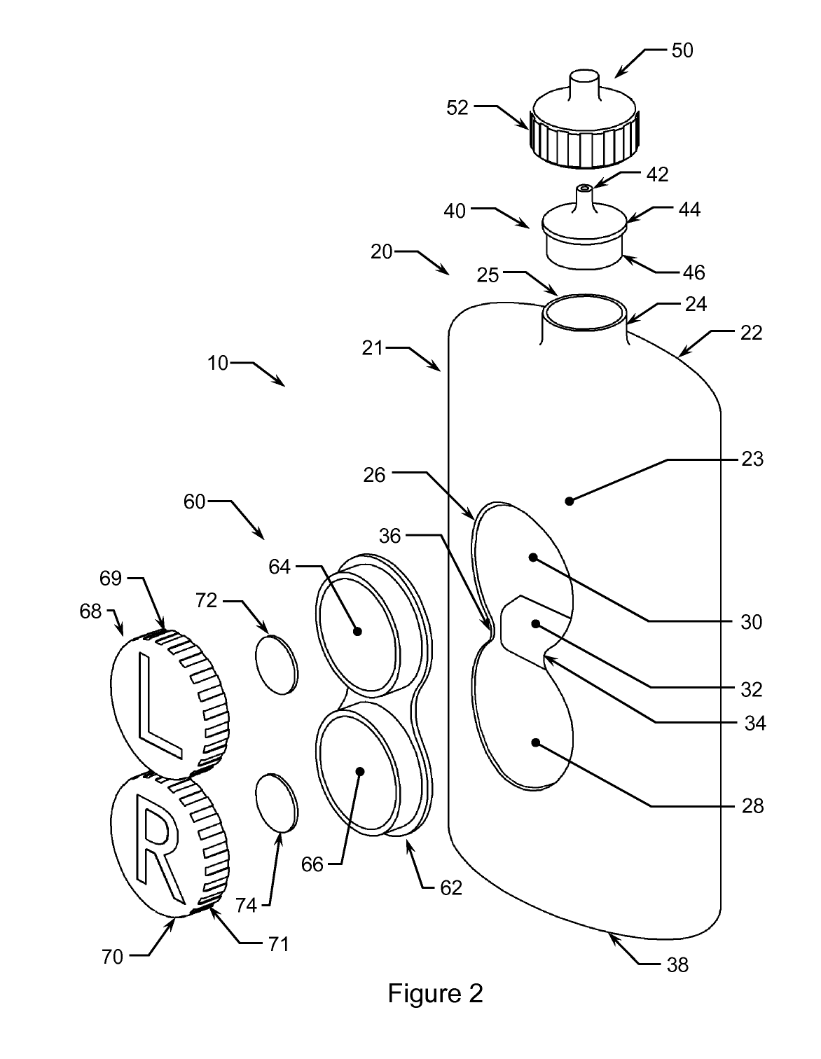

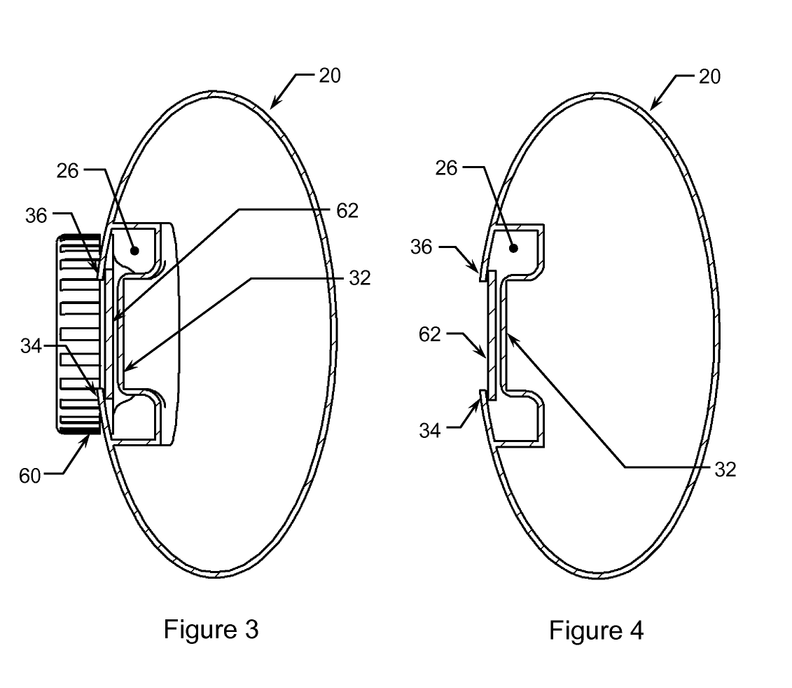

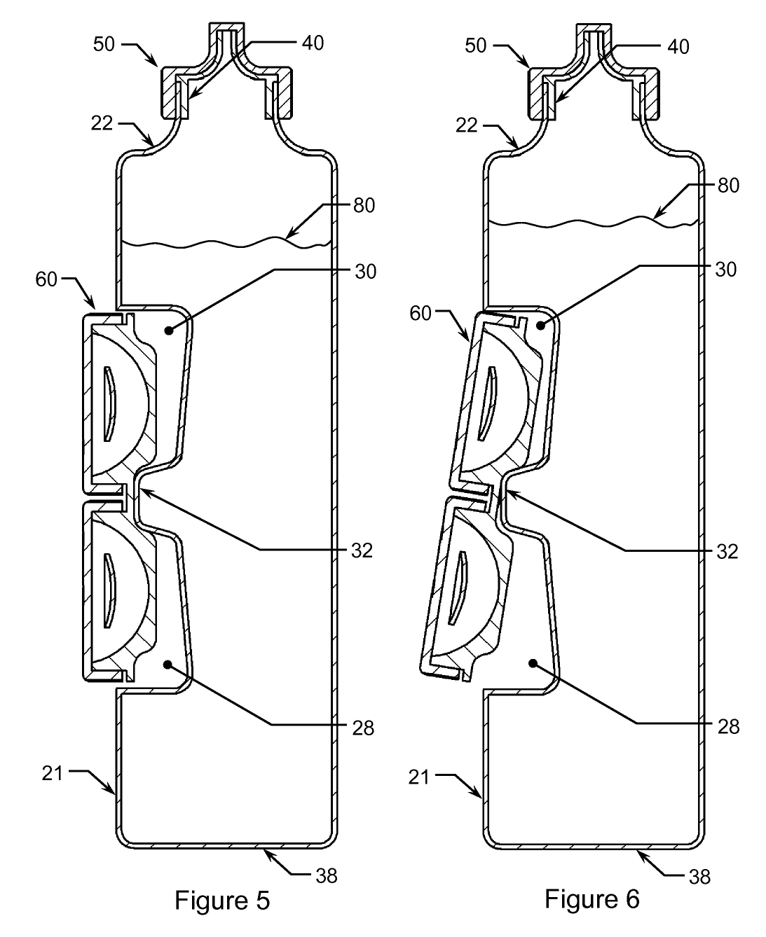

Referring now to the drawings and in particular to FIGS. 1 and 2, a first embodiment of the invention is a combined contact lens case and contact lens solution container apparatus 10 for use in conveniently carrying a case of contact lenses and contact lens solution when traveling and especially when traveling on an airplane comprising a contact lens solution container 20 and a contact lens case 40. Container 20 further comprises a bottle 21, a spout 40, and a cap 50. Container 20 further preferably includes a quantity of no more than three ounces of contact lens solution 80 contained within container 20.

Bottle 21 defines a preferably plastic blow molded or alternatively rotationally molded bottle forming a generally elongated body defining a height, a width, a thickness, and an inner cavity. Bottle 21 further includes top 22, at least one side 23, a neck 24, a mouth 25, a pocket 26, and a bottom 38. Neck 24 preferably includes external threads to provide a means of securing cap 50 to neck 24. Pocket 26 further is preferably formed in side 23 of bottle 21 and further includes a lower recess 28, an upper recess 30, a land 32 formed between and connecting recesses 28 and 30, a first retaining flange 34, and a second retaining flange 36. Land 32 preferably includes sides that taper in transition between said recesses 28 and 30 to form a bridge between said recesses 28 and 30. Retaining flanges 34 and 36 are preferably flexible enough to readily temporarily deform so as to snappingly receive a contact lens case and yet stiff enough to securely retain a contact lens case.

Spout 40 defines a preferably plastic injection molded spout forming a generally hollow cylindrical shape and having a nozzle 42, a flange 44, and a collar 46. Cap 50 defines a preferably plastic injection molded cap forming a generally hollow conical shape and having a knurled surface 52 to facilitate grasping cap 50. Cap 50 preferably includes internal threads to provide a means of securing cap 50 to neck 24 of bottle 21.

Contact lens case 60 defines a preferably off-the-shelf type contact lens case such the cases that are sold under the trade names of Alcon and Bausch & Lomb. Contact lens case 60 further defines a case having a base member 62, a left lens lid 68, and a right lens lid 70. Base member 62 defines a preferably plastic injection molded base forming a generally elongated flat base having a left lens receiving recess 64 and a right lens receiving recess 66. Recesses 64 and 66 preferably include external threads to provide a means of securing lids 68 and 70 to recesses 64 and 66 respectively. Left lens lid 68, and a right lens lid 70 define preferably plastic injection molded lids having knurled surfaces 69 and 71 respectively to facilitate grasping of lids 68 and 70 respectively. Lids 68 and 70 further preferably include internal threads to provide a means of securing lids 68 and 70 to recesses 64 and 66 respectively. Case 60 further preferably includes a left conventional contact lens 72 and contact lens solution 80 in left lens receiving recess 64 and a right conventional contact lens 74 and contact lens solution 80 in right lens receiving recess 66.

Container 20 assembled such that a quantity of no more than three ounces of contact lens solution 80 is placed in bottle 21, spout 40 is inserted into mouth 25 such that collar 46 is substantially water-tightly slid within mouth 25 until flange 44 abuts mouth 25, and cap 50 is threadingly attached to neck 24 to form a substantially water-tight seal. Case 60 is assembled such that left contact lens 72 and a moderate quantity of contact lens solution 80 is placed in left lens receiving recess 64, right contact lens 74 and a moderate quantity of contact lens solution 80 is placed in right lens receiving recess 66, and lids 68 and 70 are threadingly attached to recesses 64 and 66 respectively to form substantially water-tight seals. Apparatus 10 is assembled such that case 60 is pressed into snap-in engagement in pocket 26 of bottle 21 such that base member 62 is retained in pocket 26 by retaining flanges 34 and 36.

In practice, a user may access lenses 72 and 74 by merely pressing on either of lid 68 or 70 causing case 60 to rock or move about land 32 and causing one end of case 60 to be somewhat further buried into one of recesses 28 and 30, and causing an opposite end of case 60 to be somewhat ejected from one of recesses 28 and 30, and causing base member 62 to become un-snapped from retaining flanges 34 and 36. An exemplary method of performing the aforementioned disengagement task is defined as a user holding the apparatus in the palm of a hand of the user and the user using the thumb of the hand that is holding the apparatus to press on one end of the engaged case to cause the case to become disengaged. The user may then conventionally remove lids 68 and 70 from recesses 64 and 66 and access lenses 72 and 74. Further the user may then conventionally remove cap 50 from bottle 21 and add solution 80 to recesses 64 and 66 as needed by squeezing container 60 to cause solution 80 to be emitted from nozzle 42. Because apparatus 10 conveniently provides a side mounted snap-in engagement contact lens case mounted to the side of a contact lens solution container, and because the capacity of the container is no more than three ounces of contact lens solution, a convenient-to-use contact lens travel apparatus that is permissible to carry onto an aircraft is provided.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for containing contact lenses and contact lens solution comprising:
a contact lens case having at least one contact lens storage compartment, said compartment having a removable cover to provide access to the inner contents of said compartment; and
a contact lens solution container defining a bottle having an inner cavity and a neck terminating in a mouth, a spout, and a cap, wherein said spout is inserted into said mouth and wherein said cap is attached to said neck, and wherein bottle further includes a top, a bottom, and at least one side, and wherein said bottle includes a pocket formed in an external surface of said at least one side of said bottle, and wherein said container defines a container having a solution containing capacity of no more than three ounces of solution;
and wherein said case is cantileverly snappingly engaged into and disengagable from said pocket.

2. The apparatus of claim 1, wherein said pocket includes a first recess and a second recess, and wherein said pocket includes a land that forms a fulcrum bridge between said first recess and a second recess, and wherein said pocket includes at least one retention flange.

3. The apparatus of claim 2, wherein when said case is snappingly engaged into said pocket said at least one retention flange retains said case in said pocket, and wherein when a load is placed on a first end of said case, said case pivots about said fulcrum bridge and said case first end is moved further into a said pocket first recess and said case second end is at least partially ejected from said pocket second recess such that said case becomes disengaged from said pocket.

4. The apparatus of claim 1, wherein when said case includes a plurality of contact lens storage compartments.

5. The apparatus of claim 1, wherein when said contact lens storage compartment contains at least one contact lens, and wherein said container contains a volume of contact lens solution of no more than three ounces.

6. An apparatus for containing contact lenses and contact lens solution comprising:
a contact lens case having at least one contact lens storage compartment; and
a contact lens solution container having an inner cavity,. a top, a bottom, and at least one side, and wherein said container includes a pocket formed in an external surface of said at least one side of said container;
and wherein said case is cantileverly snappingly engaged into and disengagable from said pocket.

7. The apparatus of claim 6, and wherein said container defines a container having a solution containing capacity of no more than three ounces of solution.

8. The apparatus of claim 6, wherein when said container defines an assembly of a bottle, a nozzle, and a cap, and wherein said bottle includes a bottom, at least one side, a top, and a neck terminating in a mouth, and wherein said nozzle is inserted into said mouth, and wherein said cap is attached to said neck of said bottle, and wherein said pocket is located in a side of said bottle.

9. The apparatus of claim 8, and wherein said bottle defines a bottle having a solution containing capacity of no more than three ounces of solution.

10. The apparatus of claim 6, wherein said pocket includes a first recess and a second recess, and wherein said pocket includes a land that forms a fulcrum bridge between said first recess and a second recess, and wherein said pocket includes at least one retention flange.

11. The apparatus of claim 10, wherein when said case is snappingly engaged into said pocket said at least one retention flange retains said case in said pocket, and wherein when a load is placed on a first end of said case, said case pivots about said fulcrum bridge and said case first end is moved further into a said pocket first recess and said case second end is at least partially ejected from said pocket second recess such that said case becomes disengaged from said pocket.

12. The apparatus of claim 6, wherein when said case includes a plurality of contact lens storage compartments.

13. The apparatus of claim 6, wherein when said contact lens storage compartment contains at least one contact lens, and wherein said container contains a volume of contact lens solution of no more than three ounces.

14. An apparatus for containing contact lenses and contact lens solution comprising:
a contact lens case having at least one contact lens storage compartment; and
a contact lens solution container having an inner cavity and a pocket formed in an external surface of said container, wherein said container defines a container having a solution containing capacity of no more than three ounces of solution;
and wherein said case is cantileverly removably attached to said pocket.

15. The apparatus of claim 14, and wherein said container defines a container having a bottom, at least one side, and a top, and wherein said pocket is formed in said at least one side of said container.

16. The apparatus of claim 14, wherein when said container defines an assembly of a bottle, a nozzle, and a cap, and wherein said bottle includes a bottom, at least one side, a top, and a neck terminating in a mouth, and wherein said nozzle is inserted into said mouth, and wherein said cap is attached to said neck of said bottle, and wherein said pocket is located in a side of said bottle.

17. The apparatus of claim 16, wherein when a load is placed on said case, said case pivots.

18. The apparatus of claim 14, wherein said pocket includes a first recess and a second recess, and wherein said pocket includes a land that forms a fulcrum bridge between said first recess and a second recess, and wherein said pocket includes at least one retention flange.

19. The apparatus of claim 18, wherein when said case is snappingly engaged into said pocket said at least one retention flange retains said case in said pocket, and wherein when a load is placed on a first end of said case, said case pivots about said fulcrum bridge and said case first end is moved further into a said pocket first recess and said case second end is at least partially ejected from said pocket second recess such that said case becomes disengaged from said pocket.

20. The apparatus of claim 14, wherein when said case includes a plurality of contact lens storage compartments.

21. The apparatus of claim 14, wherein when a load is placed on said case, said case pivots, and wherein said contact lens storage compartment contains at least one contact lens.
